(19) United States
(12) Patent Application Publication
(10) Pub. No.: US 2010/0203266 A1
(43) Pub. Date: Aug. 12, 2010

(54) COATED CARDBOARD WITH MARKING ELEMENT AND METHOD OF MARKING SAID CARDBOARD

(75) Inventor: Christian Helly, Longuenesse (FR)

Correspondence Address: YOUNG & THOMPSON, 209 Madison Street, Suite 500, Alexandria, VA, 22314, US

(73) Assignee: CASCADES BLENDECQUES SAS, Blendecques (FR)

(21) Appl. No.: 12/278,215

(22) PCT Filed: Jan. 31, 2007
(86) PCT No.: PCT/FR2007/000180

§ 371 Date: Aug. 4, 2008

(30) Foreign Application Priority Data
Feb. 3, 2006 (FR) 06.00982

(51) Int. Cl. B44F 1/10; B41M 5/00

(52) U.S. Cl. 428/29; 427/145

(57) ABSTRACT

Coating cardboard, for producing packaging, formed of a (natural-) fibre-based support layer covered on at least one of its faces by a pigment layer, includes a fluorescent compound disposed discontinuously on the surface of the support layer, between the support layer and the pigment layer, the compound being invisible to natural light and visible under UV irradiation through the pigment layer, and constituting a marking element of the cardboard, without altering the printability properties of the outer face of the pigment layer. In the method of marking a coated cardboard, the marking element is applied according to a discontinuous surface, by an aqueous solution or dispersion containing the fluorescent compound, to the surface of the face of the support layer which is intended to be covered subsequently by the pigment layer, by for example flexographic printing or spraying. The marking element may serve as a distinctive sign or security sign.

This invention relates to a coated cardboard, in particular for packaging, provided with a marking element, as well as the process for marking said cardboard.

Coated cardboards can be defined as materials that are formed by the superposition of a substrate layer, for the most part based on natural fibers such as cellulose fibers, and a pigmentary layer. If the substrate layer is slightly gray, the coating that forms the pigmentary layer can be, for example, based on pigments that are more clear or white, and thus make possible its subsequent printing.

The elements for marking paper or cardboard are elements for authentication or recognition that are affixed to or incorporated into paper or cardboard, in particular to prevent counterfeiting.

The marking elements known to date are divided into two large categories.

The first category includes marking elements that are applied to or made on the paper or finished cardboard, i.e., after the production of the material itself. These marking elements are, for example, colored inks or fluorescent inks, namely inks that contain a compound that exhibits a fluorescence during its irradiation by ultraviolet rays, which are printed on an outer surface of the finished material, for example a fiduciary paper.

This surface printing exhibits the drawback of being erasable (for example by rubbing, wear, chemical diluents, . . . ), forgeable or that can be quite easily counterfeited, in particular by affixing similar marking elements to substrates of other origins.

The second category includes marking elements that are incorporated into the paper or cardboard material during its production. These are, for example, metal filaments, or fluorescent fibers, or solid elements that are inserted among the fibers that compose said paper or cardboard.

These processes for incorporating marking elements are complex and costly implementations. In addition, they can be easily detected with the naked eye, in particular if they create excess thicknesses of the material, appear just under the outer surface, or are transparent. It is sometimes undesirable that the existence of these marking elements can be seen by the user or the possible counterfeiter.

According to WO 2005/014928, other marking elements, such as fluorescent or phosphorescent elements that are incorporated into the pigmentary layer, applied in a conventional manner, over the entire surface for the substrate layer, are known. To create a marking element that is specific to the user of the cardboard, various possibilities are provided to modify the physical or chemical nature of the marking element itself. These processes involve modifying the coating formulation each time; this creates significant constraints, in particular for on-line applications.

At certain predetermined spots, other types of known marking modify the thickness of the material by carrying out a sort of “embossing” of the paper or the cardboard: the implementation process also requires, as in the preceding case, a particular device. In addition, the surface of the material is altered in these zones in such a way that it is subsequently difficult to print on them.

The purpose of this invention is therefore to eliminate the above-mentioned drawbacks by proposing a coated cardboard that incorporates a marking element that can be used in particular as a safety or monitoring element, difficult to reproduce and unforgeable, invisible to the naked eye. Another object of the invention is to propose a process for installing such a simple, inexpensive marking element that can be adjusted according to the wishes of the user of the cardboard and can be adapted to an on-line process.

For this purpose, according to the invention, the coated cardboard, in particular for packaging, formed by a substrate layer that is based on fibers that are for the most part cellulose and that is covered—on at least one of its surfaces—with a pigmentary layer, is characterized in that a fluorescent compound is used intermittently on the surface of the substrate layer between said substrate layer and the pigmentary layer, whereby said compound is invisible in the natural light and visible under U.V. irradiation through the pigmentary layer and thus constitutes a marking element of said cardboard.

Thus, the composition of each of the layers is maintained without a major modification: the substrate layer and the pigmentary layer are produced in a conventional manner, and the cardboard can be used as packaging under the same conditions as in the absence of the marking element: the presence of the marking element according to this invention allows the subsequent printing on the surface of the pigmentary layer, without altering printability qualities of the outer surface of the pigmentary layer at the marking site. Actually, after drying, the pigmentary layer continues to have a uniform thickness and a homogeneous structure, including in the zones that cover the marking.

The marking element that is formed by the simple application of a fluorescent compound is thus used in the core of the cardboard and is thereby inviolable and unforgeable. It is invisible to the naked eye, through either the pigmentary layer or the substrate layer, because it produces neither excess thickness in the material nor modification of the surface state of the pigmentary layer that can be observed in low light, nor even local modification of the absorption properties of inks through the pigmentary layer, which would be applied subsequently to the surface of the latter.

Advantageously, the pigmentary layer consists of mineral pigments that are slightly opaque to ultraviolet rays for excitation of the fluorescent compound as well as to the light that is emitted at its emission wavelength when it fluoresces. This pigmentary layer can be formed by, for example, an aqueous dispersion of a conventional stationery coating binder based on styrene-butadiene latex, containing mineral pigments such as kaolin and/or calcium carbonate and conventional additives of a coating formula (dispersing, anti-foam, viscosity modifiers, . . . ). The pigmentary layer has a small thickness (for example between 12 and 30 micrometers of mean thickness). Thus, during the irradiation of the surface of the cardboard by ultraviolet rays, the marking compound is excited and is made fluorescent: it then becomes visible through irregular fabric formed by the layer that contains the pigments.

The marking is done along a discontinuous surface, in the form of (a) line(s), (a) dash(es) and/or text and/or pattern(s): it can show, for example, the logo of the manufacturer of the cardboard or the product to be packaged, or any other distinctive sign or safety sign.

According to a first embodiment of the invention, the marking element is formed by a varnish, for example an acrylic-based varnish that contains approximately 0.2 to 1.2% by weight of said fluorescent compound, preferably approximately 0.4 to 0.8% by weight. The varnish is preferably water-dilutable, so as not to introduce solvent into the cardboard, in particular when the latter is designed for the packaging of food, but to allow an impregnation of fibers on the surface of the substrate layer. After dilution, said varnish has a dry extract that is advantageously between approximately 20 and 27% by weight.

The grammage of the dry varnish at the discontinuous marking zones is advantageously less than 2 g/m², preferably less than 1.5 g/m², and even less than 1 g/m². It involves a smaller amount of varnish (on the order of two times less) than the one usually deposited in the case of printing on non-coated cardboard, visible to the naked eye with a conventional ink or varnish.

According to a second embodiment of the invention, the fluorescent compound is introduced in the form of a solution or an aqueous dispersion. The presence of water is advantageous, so as to allow an impregnation of cellulose fibers on the surface of the substrate layer and a presence of fluorescent compound that is concentrated locally.

However, in an advantageous manner so that the fluorescent compound does not strongly diffuse into the substrate layer and does not become less opaque and thus visible in its passage into the thickness of said layer, said substrate layer has a Cobb water absorption value of less than 50 g/m². The Cobb water absorption value measures the absorption capacity of the water in the porous mesh of the substrate, and, expressed in terms of g/m², the mass of the water that is absorbed by the substrate during a given time (1 minute by the measurement according to the NFQ 03-014 or ISO 535 standard).

By way of reference, “non-bonded” cardboard can absorb at least its own weight in water (or 200 g of water for cardboard of 200 g/m²).

In the case of a marking made on-line of the cardboard machine and preceding a pigmentary layer that is also on-line, the “bonding” of the cardboard is preferably carried out by incorporation into the cellulose paste of bonding products. These bonding products are preferably based on rosin and/or succinic anhydride, because the desired Cobb water absorption value is obtained instantaneously, unlike bonding products based on alkyl ketenes (dimers) that take several hours to polymerize. The application of the marking element can consequently immediately follow the production of the substrate layer of the cardboard and can be carried out on-line.

The substrate layer also advantageously has a surface smoothness (Bendtsen method) that is less than 500 ml/minute, obtained by calendaring and/or by friction-coating, prior to the marking. The surface smoothness corresponds to the reduction of the pore size of the surface of the substrate and is measured (according to the ISO 8791-2 standard) by placing a metal ring on its surface and by measuring the air flow (ml/minute) escaping through the upper pores of the material (by way of reference, a non-calendared and non-friction-coated cardboard has a Bendtsen surface smoothness on the order of 1500 ml/minute).

This invention also relates to the process for installing the above-mentioned marking element, or marking, making it possible to obtain the coated cardboard described above. This marking process of a coated cardboard according to the invention comprises the production of a substrate layer that is based on fibers (for the most part cellulose), optionally friction-coating and/or calendaring of said substrate layer, its drying, then the covering of at least one surface of this substrate layer by an aqueous dispersion of mineral pigments, in the presence of a binder, designed to form the pigmentary layer, followed by drying the pigmentary layer thus formed, and it is characterized in that the marking element is applied, along a discontinuous surface, in the form of a solution or aqueous dispersion that contains the fluorescent compound, on the surface of the face of the substrate layer that is designed to be subsequently covered with the pigmentary layer.

According to a first embodiment, the incorporation of the marking element between the two layers of the cardboard is carried out by intermittent printing of a varnish, preferably water-dilutable, for example by means of printing by flexography. According to the principle of this printing process, the varnish is applied to the substrate by means of a three-roller system: a counter-pressure cylinder facing the surface to be printed, and, on the front side to be printed, a roller that carries a relief printing plate, and a gravure roller. The varnish that contains said fluorescent compound is deposited into the gravure cells by a metering system (blade-type chamber or a fountain roller in a barrel containing the varnish). The varnish is then transferred from the gravure cells to the relief printing plate, which then puts back the varnish on the substrate layer.

For this purpose, the viscosity of the varnish that contains the fluorescent compound is advantageously low to facilitate the printing and to apply only a small amount of varnish. Usually, the flow time of the varnish is measured, and this is preferably between 15 and 30 s in the AFNOR cup No. 4 (according to the AFNOR NF T 30014 standard of September 1983).

According to a second embodiment, the marking element is applied by spraying, advantageously in an amount of between 10 and 100 ml/m² of solution or aqueous dispersion that contains between 0.5 and 3% by weight of fluorescent compound.

As indicated above, when the marking is combined with on-line coating of the machine that is producing the cardboard, it is also preferable that the substrate layer, which is to receive the application of the marking element, be treated in the mass of fibers by a bonding product with a base of rosin and/or succinic anhydride and/or any other product that makes it possible to achieve in a drier a Cobb water absorption value of less than 50 g/m² immediately, so as to limit—in the next stage—the penetration of the fluorescent compound into the substrate layer.

The cardboard that is produced according to this invention, provided with distinctive marking according to the invention and representing, for example, the logo of the corresponding pharmaceutical laboratory or product line, can be used for the production of packages such as medicine boxes, food products or industrial replacement parts. This distinctive marking is advantageously placed on the cardboard at regular intervals such that at least one complete logo is visible in its entirety on an area that is not covered with the final printing ink of each box. The marking can thus be detected and authenticated by exposing the boxes to a UV irradiation source by the parties involved in the product distribution chain or, if necessary, in the customs services, or in combating fraud, and advantageously by comparing it to the marking of a control box whose authenticity was previously guaranteed.

This invention will now be described in more detail using two illustrative examples.

On a multi-jet- or single-jet-type machine, a cardboard sheet is conventionally produced continuously by a stationery process for forming a sheet on formers, a pressing section, and a multi-cylindrical drier. This material with a thickness of between approximately 350 and 875 micrometers is friction-coated and calendared to improve its surface state and thus constitutes the substrate layer of the cardboard. On the upper face of this substrate layer, at least one homogeneous pigmentary layer is then conventionally applied by means of a coating station that is equipped with, for example, a rotating pencil or a smoothing blade, or an air knife.

### EXAMPLE 1

### Marking by Flexography

According to a first embodiment of the invention, before the application of the pigmentary layer, printing is initiated, on the substrate layer, of marking patterns by means of a varnish that contains a fluorescent compound.

The varnish is a mat acrylic varnish, water-dilutable, with 26% by weight of dry extract and a viscosity of between 20 and 30 s., at 23° C. (G/ESC 345 of the SIEGWERK Company, diluted with water in the proportion of 1 kg of water per 2 kg of varnish). After dilution, it contains approximately 0.8% by weight of fluorescent compound (4% by weight of an optical brightening agent 85ZI054047 of the SIEGWERK Company, at 20% by weight of dry extract, visible under wavelengths of 210 to 350 nm, with a maximum absorbance at 274 nm).

The intermittent printing of the varnish is carried out on the substrate layer by flexography by means of a cylindrical gravure roller that has a small volume of gravure cells, namely on the order of 5 to 9 cm³ per m² so as to apply only a small amount of varnish. In particular, this ensures that the presence of varnish has absolutely no impact on the final printability characteristics of the pigmentary layer, which remains homogeneous.

Actually, in the flexographic process, these are the characteristics of the gravure cells (number of lines of gravure cells per unit of circumferential length of the gravure cylinder and volume of the gravure cells per unit of surface area of the cylinder), which still make it possible to control the parameter that determines the dry grammage of deposited varnish.

So as to implement printing that is not visible to the naked eye through the pigmentary layer and not to modify the surface state or the characteristics of the pigmentary layer at the marking, it has been noted that it was suitable to apply an amount of varnish that is reduced by 2 to 3 times relative to the grammage of varnish that is usually deposited in the case of standard printing.

Consequently, the selection of the characteristics of the gravure cells of the gravure cylinder is suitable for this requirement. For the printing of characters or logos on this type of non-coated substrate, the selection of characteristics of the gravure cells relates in general to a volume of gravure cells of 10 to 12 cm³/m² and a weft of 80 to 100 lines/cm. In the case of this invention, the selection relates to a volume of gravure cells of 5 to 9 cm³/m² and a weft of 120 to 180 lines/cm, making it possible to deposit on the surface of the substrate layer a grammage of dry varnish of less than 2 g/m², preferably less than 1.5 g/m².

Thus, the pigmentary layer that is applied in the final stage dries in a uniform manner, without creating zones of different structure and porosity, between the zones superposed with the marking pattern and those where the marking is not superposed.

The printing speed of the varnish is between 80 and 350 m/minute, i.e., it is compatible with the speeds of the machines for producing cardboard; the printing can therefore be carried out on-line during the production of cardboard.

The varnish is printed in the form of patterns that are uniformly spaced from one another over the entire surface of the substrate layer (here, eight patterns over 100 cm²). The printing is carried out at ambient temperature (15 to 30° C.), and the substrate layer of the cardboard has a moisture level of about 7% by weight.

### EXAMPLE 2

### Marking by Spraying

According to a second embodiment of the invention, before the application of the pigmentary layer, the application, on the substrate layer, of marking is initiated by means of an aqueous solution that contains approximately 2% by weight of fluorescent compound (10% by weight of an optical brightening agent Tinopal ABP-A of the CIBA Company, at 20% by weight of dry extract). This solution can also contain additives whose object is to optimize the application and to adapt to the properties of the substrate in particular with regard to the water absorption capacity.

The application of said marking solution on the substrate layer is carried out by spraying by means of fine nozzles of approximately 0.3 mm in orifice diameter so as to apply only a small amount of solution. In particular, this ensures that the presence of marking has absolutely no impact on the final printability characteristics of the pigmentary layer, which remains homogeneous. The selection of the spacing between the nozzles, the angle of the jet, and the possibility of carrying out intermittent spraying makes it possible to obtain a discontinuous and distinctive marking.

So as to implement an application that is not visible to the naked eye through the pigmentary layer and to not modify the surface state or the characteristics of the pigmentary layer at the marking, it has been noted that it was suitable to apply a limited amount of marking solution (a maximum of approximately 100 ml/m²). This amount is to be adjusted based on the absorption capacity of the substrate and the intensity of the marking that is to be obtained.

Consequently, the selection of the characteristics of the nozzles and the operating pressures is adapted to this requirement. In the case of this example, the selection relates to a TP 000019-SS nozzle of the Spraying System Company operated at a pressure of between 30 and 75 cm of water column that makes it possible to deposit an amount of marking solution of between 15 and 75 ml/m² on the surface of the substrate layer.

The application is implemented at the outlet of the drier, whereby the substrate layer of the cardboard has a moisture level of approximately 2% to 4% by weight. It is also possible to carry out this type of application at various points between the production stage of the substrate layer and the stage for coating the cardboard.

After the application of the marking according to one of the embodiments above, the coating operation is then carried out conventionally. However, the pigmentary layer preferably does not contain optical brightening agent, and if it does contain it, the latter advantageously emits at wavelengths that are different from those of the marking element. The titanium dioxide being a pigment that is too opaque to ultraviolet radiation, its use is to be restricted (up to 10% by weight, preferably approximately 8% of the total weight of the pigments of the pigmentary layer). Kaolin and calcium carbonate are preferred. However, in the case where the substrate cardboard consists of recycled fibers that already contain optical brightening agents, the use of titanium dioxide actually makes it possible to mask the residual fluorescence of fibers and thus to better bring out, by contrast, the marking under exposure to UV radiation.

In the two examples presented, the pigmentary layer is applied in two stages in the form of a grammage prelayer of between 13 and 18 g/m² (starting from an aqueous dispersion that contains mineral pigments, namely equal proportions of kaolin K1 1020 of the Kaolin International BV Company and calcium carbonate Carbital 60 of the IMERYS Company, in the presence of a binder based on styrene-butadiene latex and various traditional coating additives in minority amounts that have a dry material level of 67% by weight), then covered with an upper grammage layer of between 10 and 12 g/m² (starting from an aqueous dispersion that contains calcium carbonate, Carbilux of the IMERYS Company, and a binder that is based on styrene-butadiene-type latex, combined with traditional coating additives in minority amounts) with 68.5% by weight of dry material.

The drying of the pigmentary layer is then carried out either by a hot-air drying system or by an infra-red drying system, which may or may not be combined with conventional drying cylinders.

It was noted, surprisingly enough, that such a pigmentary layer certainly impairs the fluorescence because of a certain inherent opacity of the coating pigments used, but it does not prevent a very distinct reading of the marking under U.V. light, for example under a lamp of the type that is usually used by philatelists, whose maximum intensity is obtained for a wavelength of close to 366 nm.

In visible light, the marking cannot be detected at all with the naked eye.

1. Coated cardboard, in particular for packaging, formed by a substrate layer that is based for the most part on cellulose fibers, covered on at least one of its surfaces by a pigmentary layer, characterized in that a fluorescent compound is placed discontinuously on the surface of the substrate layer between said substrate layer and the pigmentary layer, whereby said compound is invisible in natural light and visible under U.V. irradiation through the pigmentary layer and thus constitutes a marking element of said cardboard.

2. Cardboard according to claim 1, wherein the pigmentary layer contains mineral pigments that are slightly opaque to ultraviolet rays for excitation of the fluorescent compound as well as to the light emitted at its emission wavelength when it fluoresces.

3. Cardboard according to claim 2, wherein the pigmentary layer is formed by a binder that is based on styrene-butadiene latex, containing kaolin and/or calcium carbonate.

4. Cardboard according to claim 1, wherein the marking element is formed by a varnish that contains approximately 0.2 to 1.2%, preferably approximately 0.4 to 0.8% by weight of said fluorescent compound.

5. Cardboard according to claim 4, wherein the varnish is a water-dilutable varnish.

6. Cardboard according to claim 1, wherein the substrate layer has a Cobb water absorption value of less than 50 g/m².

7. Cardboard according to claim 1, wherein the substrate layer has a Bendtsen surface smoothness of less than 500 ml/minute (measured according to the ISO 8791-2 standard).

8. Cardboard according to claim 5, wherein the marking is discontinuous, in the form of (a) line(s), (a) dash(es) and/or text and/or pattern(s), whereby the grammage of the dry varnish at the marking zone is less than 2 g/m², preferably less than 1.5 g/m².

9. Process for the production of a coated cardboard that is provided with a marking according to claim 1, comprising the production of a substrate layer based on fibers that are for the most part cellulose and its drying, then the covering of at least one surface of this substrate layer by an aqueous dispersion of mineral pigments, in the presence of a binder, designed to form the pigmentary layer, followed by the drying of the thus formed pigmentary layer, wherein the marking element is applied, along a discontinuous surface, in the form of a solution or aqueous dispersion that contains the fluorescent compound, on the surface of the face of the substrate layer that is designed to then be covered with the pigmentary layer.

10. Process according to claim 9, wherein the substrate layer that is to receive the application of the marking element is treated in the mass of fibers by a bonding product based on rosin and/or succinic anhydride that make it possible to achieve in a drier a Cobb water absorption value of less than 50 g/m² immediately, so as to limit in the next stage the penetration of the fluorescent compound in the substrate layer.

11. Process according to claim 9, wherein the marking element is applied by intermittent printing of a varnish, preferably water-dilutable.

12. Process according to claim 11, wherein the printing of the varnish is carried out by flexography.

13. Process according to claim 12, wherein the printing by flexography is carried out by means of a cylindrical gravure roller that has a volume of gravure cells of 5 to 9 cm³/m² with a weft of 120 to 180 lines/cm, making it possible to deposit on the surface of the substrate layer a grammage of dry varnish of less than 2 g/m², preferably less than 1.5 g/m².

14. Process according to claim 9, wherein the marking element is applied by spraying.

15. Process according to claim 14, wherein the marking element is applied in an amount of between and 100 ml/m² of solution or aqueous dispersion that contains between 0.5 and 3% by weight of fluorescent compound.

16. Process according to claim 10, wherein the marking element is applied by intermittent printing of a varnish, preferably water-dilutable.

17. Cardboard according to claim 2, wherein the marking element is formed by a varnish that contains approximately 0.2 to 1.2%, preferably approximately 0.4 to 0.8% by weight of said fluorescent compound.

18. Cardboard according to claim 3, wherein the marking element is formed by a varnish that contains approximately 0.2 to 1.2%, preferably approximately 0.4 to 0.8% by weight of said fluorescent compound.

19. Cardboard according to claim 2, wherein the substrate layer has a Cobb water absorption value of less than 50 g/m².

20. Cardboard according to claim 2, wherein the substrate layer has a Bendtsen surface smoothness of less than 500 ml/minute (measured according to the ISO 8791-2 standard).
